(19) United States
(12) Patent Application Publication
(10) Pub. No.: US 2017/0087454 A1
(43) Pub. Date: Mar. 30, 2017

(54) Modular Holographic Game Assembly

(71) Applicant: Gregory R. Reichmuth, Denver, CO (US)

(72) Inventor: Gregory R. Reichmuth, Denver, CO (US)

(21) Appl. No.: 15/003,583

(22) Filed: Jan. 21, 2016

Related U.S. Application Data
(60) Provisional application No. 62/232,002, filed on Sep. 24, 2015.

(51) Int. Cl. A63F 13/23; A63F 9/24; A63F 13/25; A63F 13/80; A63F 3/00

(52) U.S. Cl. CPC A63F 13/23; A63F 13/80; A63F 3/00895; A63F 13/25; A63F 9/24; A63F 3/00697; A63F 2009/2451; A63F 2009/245

(57) ABSTRACT

A modular gaming apparatus allows for board games such as chess to be played on one or more levels. A base structure include a drawer and a fixed game board, with one or more playing units being provided for stacking atop the base structure. Each playing unit includes a game board, legs, and a track mechanism that allows the game board to slide out for easier player access. A virtual game piece generating unit is also provided, the virtual game piece generating unit allowing for non-physical representations of game pieces to be created. A computing system allows for pairing of electronic devices and processing by means of a processing module and a communications module. The electronic components control the virtual game piece generating unit and also allow for remote play.

The current application claims a priority to the U.S. Provisional Patent application Ser. No. 62/232,002 filed on Sep. 24, 2015.

### FIELD OF THE INVENTION

The present invention relates generally to a modular gaming table. More specifically, the present invention is a modular gaming table that allows users to play one or more board games on multiple levels with real or virtual game pieces.

### BACKGROUND OF THE INVENTION

Playing with board games is a treasured past time activity. Board games may be played in small group or in large competitions. However the storage and display of board games is limited to the box it came in and any reachable flat surface. A single gaming unit

The present invention serves to store multiple board games and play with two or more board games simultaneously. The user may slide out the different levels of the present invention so that multiple game boards are accessible at the same time. Virtual game piece generating units can be varied in different embodiments, allowing for both virtual and physical representations of game pieces to be utilized. Games can be played in person or through remote connections thanks to the integration of a communications system into the present invention.

### BRIEF DESCRIPTION OF THE DRAWINGS

FIG. 1 is a perspective view of a base structure of the present invention.

FIG. 2 is a front view of the base structure of the present invention.

FIG. 3 is a top plan view of the base structure of the present invention.

FIG. 4 is a perspective view of a playing unit atop the base structure of the present invention.

FIG. 5 is a front view of the playing unit atop the base structure of the present invention.

FIG. 6 is an exploded view showing two removed game boards of the present invention.

FIG. 7 is a perspective view showing the connection of two legs of the present invention.

FIG. 8 is a bottom perspective view showing the connection of two legs of the present invention.

FIG. 9 is a diagram showing electronic connections of the present invention.

FIG. 10 is an example illustration of a holographic embodiment of the present invention.

FIG. 11 is an example illustration of a video projection embodiment of the present invention.

FIG. 12 is an example illustration of a illumination embodiment of the present invention.

### DETAIL DESCRIPTIONS OF THE INVENTION

All illustrations of the drawings are for the purpose of describing selected versions of the present invention and are not intended to limit the scope of the present invention.

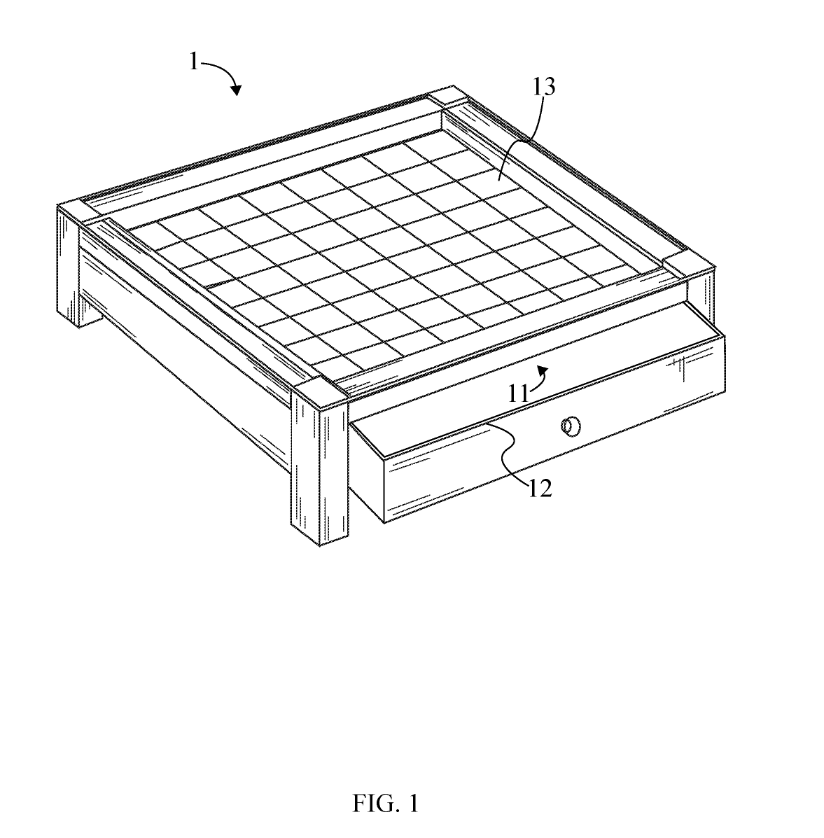

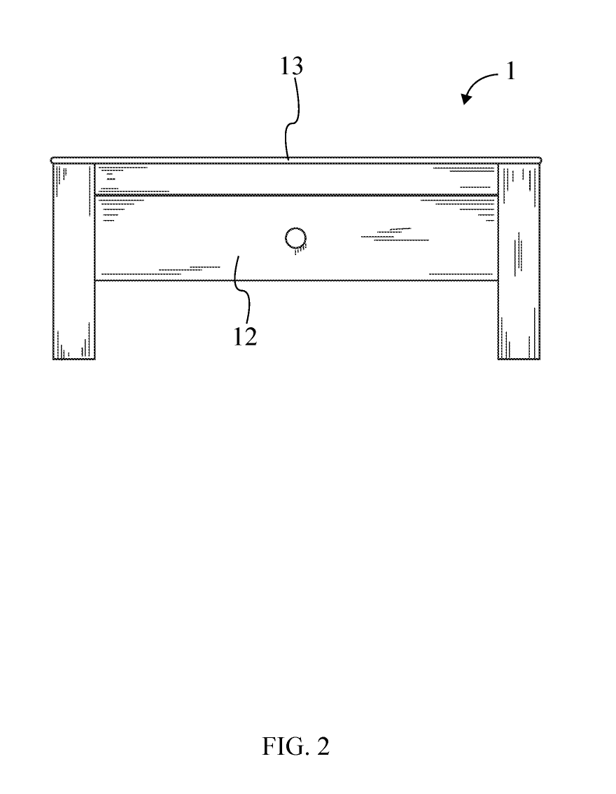

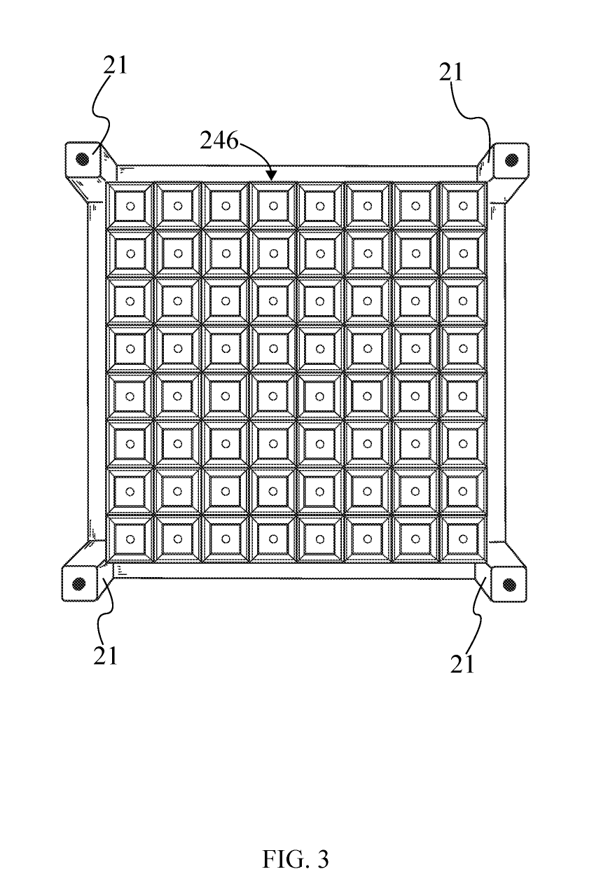

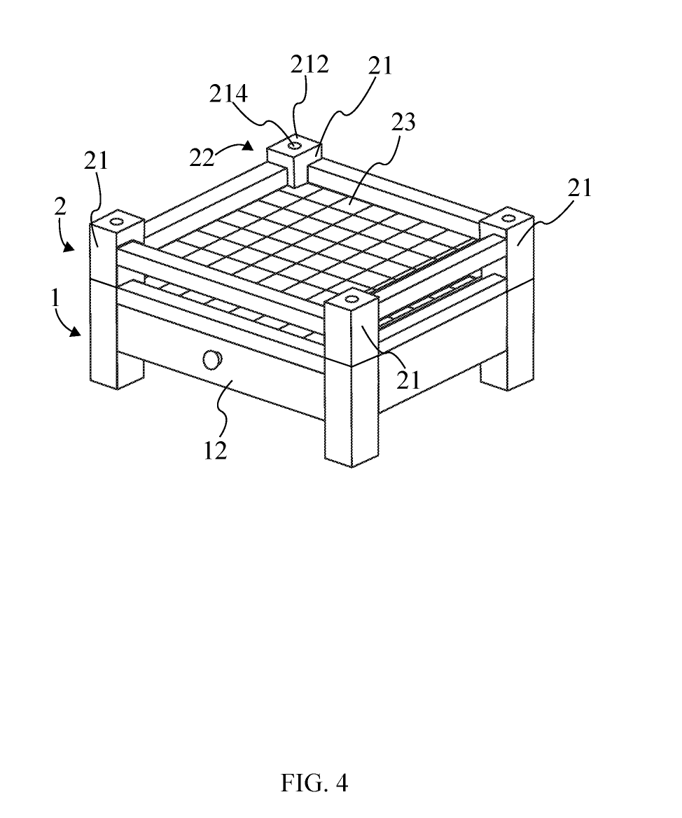

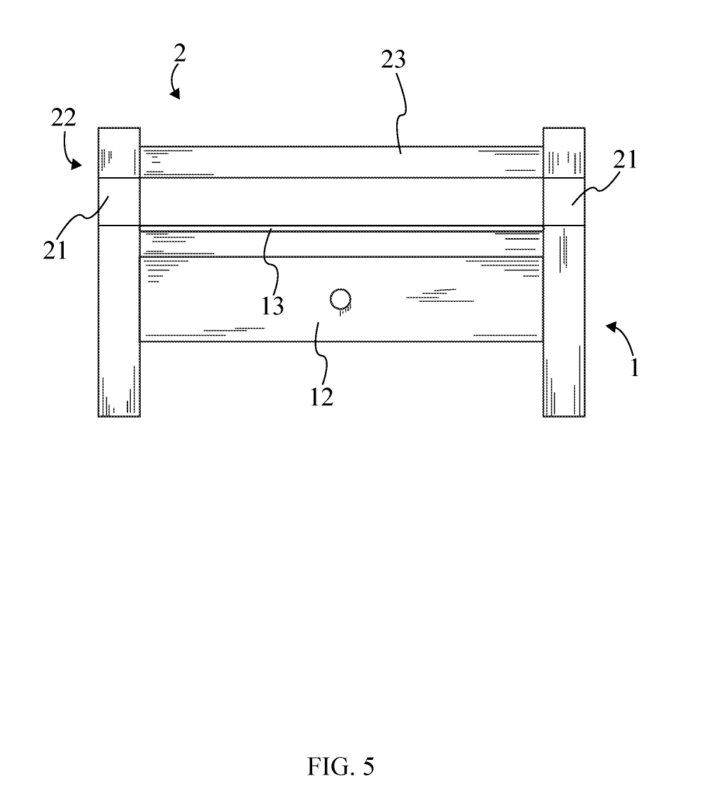

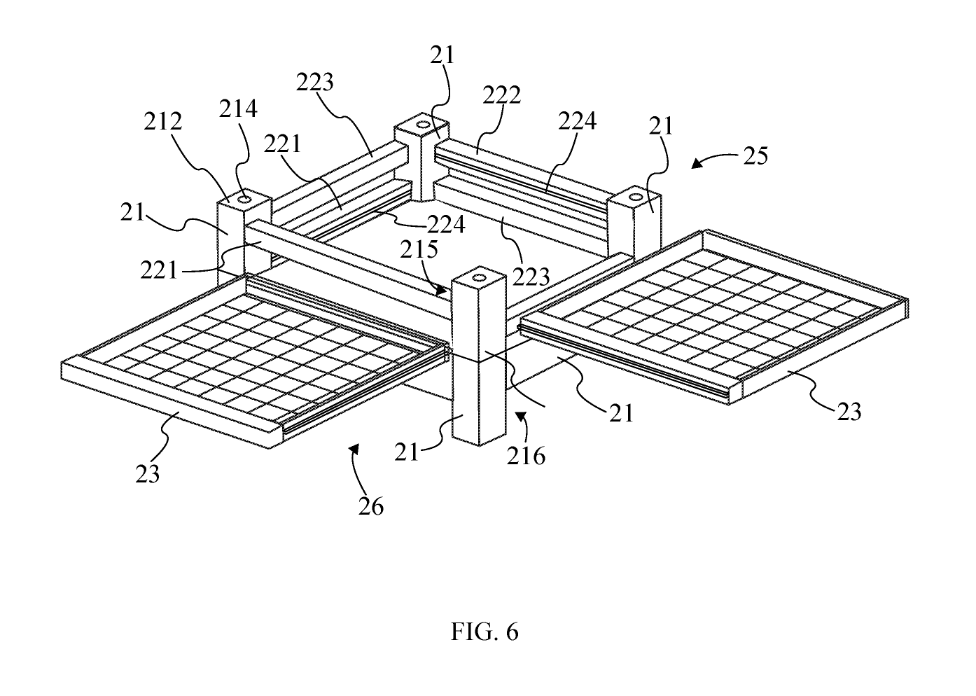

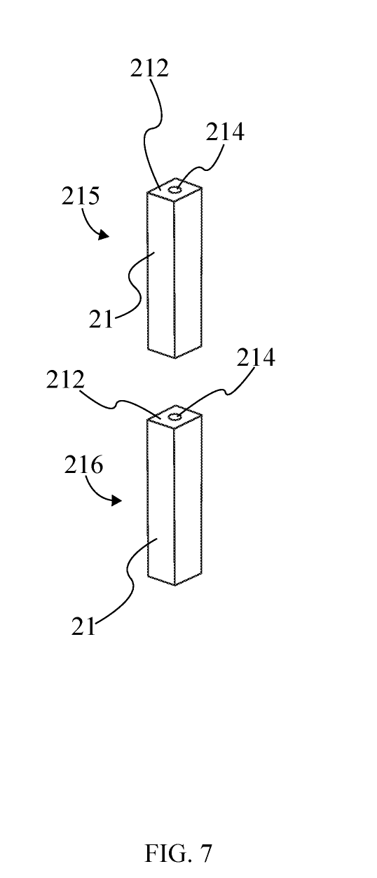

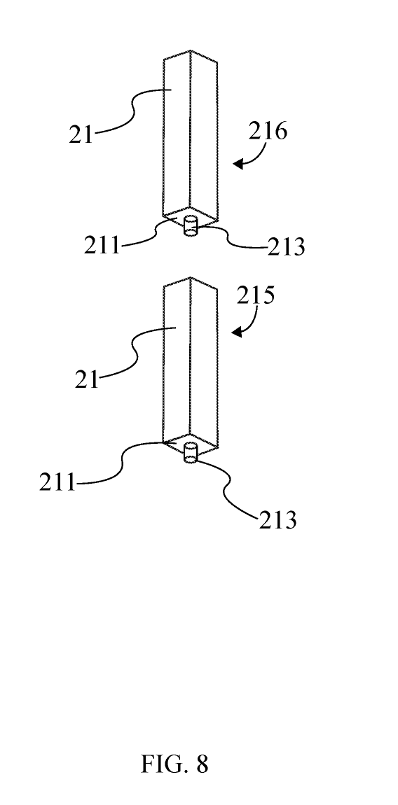

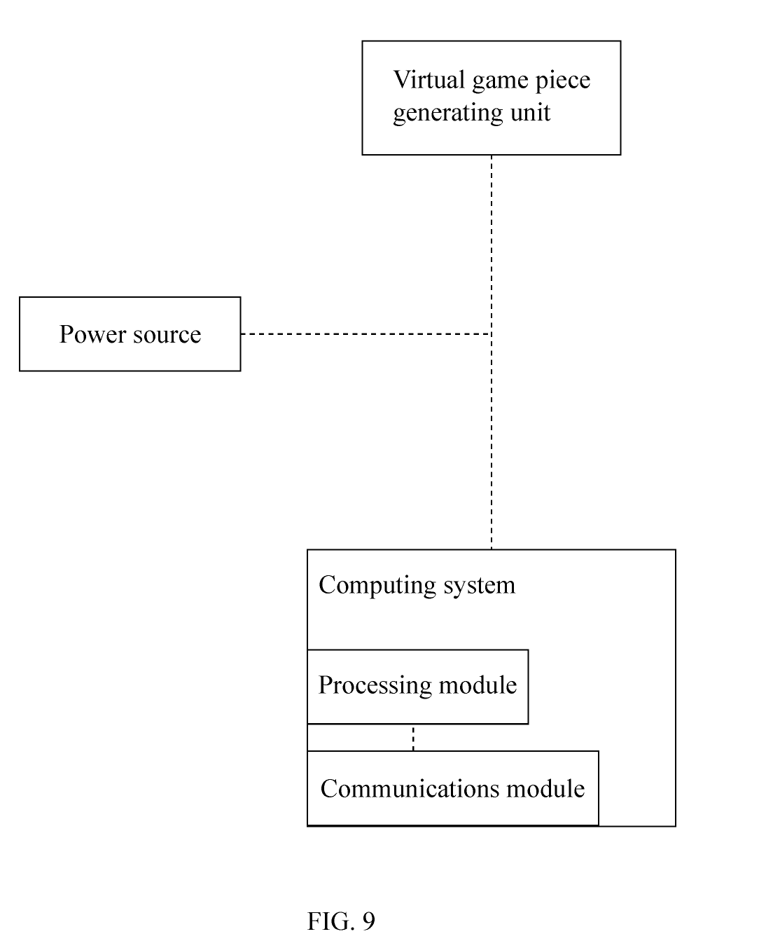

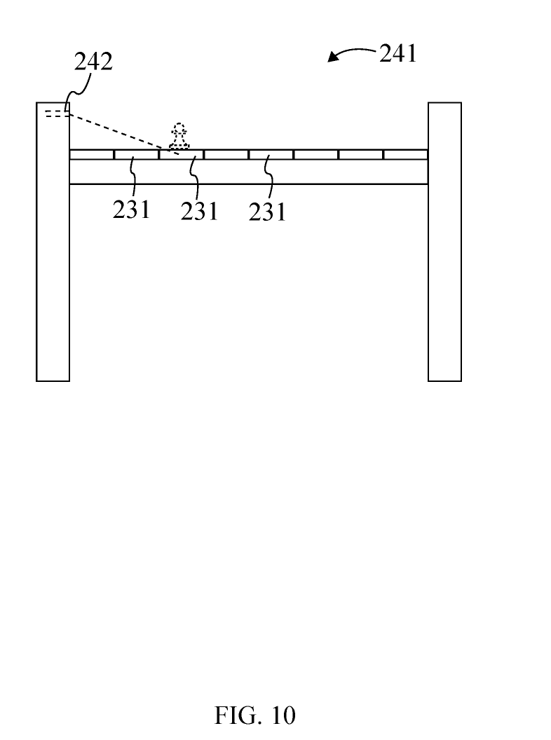

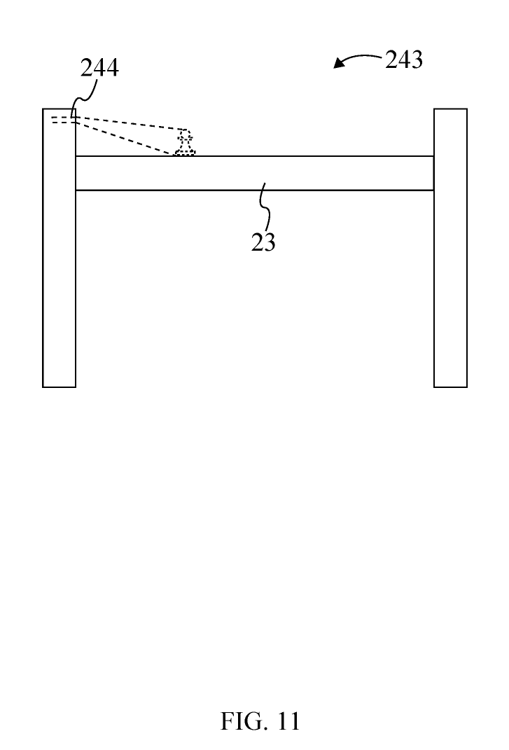

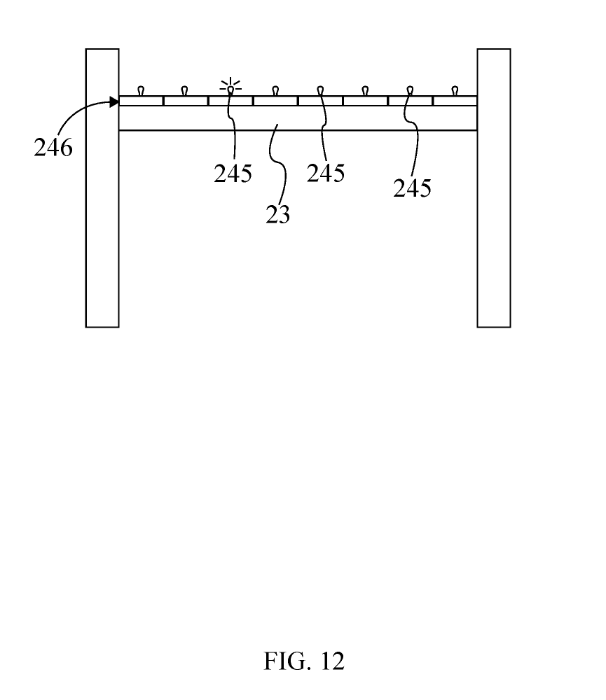

The present invention is an improved gaming table which allows for multi-level play with virtual representations of game pieces. While the present invention allows a variety of games to be played, the game of chess will be used as an example game for consistencies sake through this application. The present invention allows for chess to be played in 3 dimensions by providing multiple boards in a vertical orientation. The game of chess can be played against in-person and remote opponents, thanks to a computer system that allows for communication with third parties such as over wireless or mobile connections. The present invention is illustrated via FIG. 1-FIG. 12.

The present invention comprises a base structure 1, an at least one playing unit 2, a power source 3, and a computing system 4. The base structure 1 supports the playing unit 2, the latter allowing a game of chess to be played over two or more levels. The power source 3 provides the necessary energy for the electrical components of the present invention, including the computing system 4 and certain components of each of the playing units as subsequently introduced. the playing unit 2 comprises a plurality of legs 21, a lateral bracket 22, a game board 23, and a virtual game piece generating unit 24. The plurality of legs 21 support the other components of each playing unit, and allow for stacking of said playing units. The lateral bracket 22 receives the game board 23 and allows for the game board 23 to slide out, facilitating multilevel gameplay. The virtual game piece generating unit 24 allows for virtual game pieces to be represented on the game board 23. It is noted that the virtual game piece generating unit 24 does not preclude the use of physical game pieces; if a user desires, physical game pieces could be placed on the game board 23 in place of or alongside virtual game pieces.

The power source 3 is electrically connected to the computing system 4 and the virtual game piece generating unit 24, providing the necessary energy for the latter components to function. The power source 3 itself can be selected from a variety of types, a two examples of which include a battery or a converter (compatible with wall outlets by means of a power plug). The power source 3 is preferably housed within the base structure 1, helping to protect the electrical components from potential environmental or accidental damage. Likewise, the computing system 4 is housed within the base structure 1, affording it similar protection.

The plurality of legs 21 are connected along the lateral bracket 22. The plurality of legs 21 are also oriented to be perpendicular to the lateral bracket 22. The plurality of legs 21 are thus able to elevate the lateral bracket 22 and an associated game board 23 above a lower level component, e.g. the base structure 1 or another playing unit. The game board 23, as previously referenced, is slidably engaged into the lateral bracket 22. This relation allows the game board 23 to slide into and out of the lateral bracket 22, allowing for more convenient storage in addition to easier access when playing multilevel chess. Multiple playing units 2, if utilized, can be stacked upon each other and positioned onto the base structure 1 in order to form a three dimensional gaming structure. Potentially, any number of playing units can be utilized in combination with the present invention, though the physical reach of persons along with structural limits provide a limit of sorts; there is little point in stacking playing units so high that even a six foot tall person cannot comfortably access them.

Preferably, provided a square shape for the game board 23, the plurality of legs 21 are evenly distributed across the corners of the lateral bracket 22, with their being a total of four legs 21. This provides an optimal level of support without significantly impeding access to any playing units positioned below such a group of legs 21.

To allow for the playing units (when more than one are provided) to be stacked with one another while maintaining a connection between the virtual game piece generating unit 24 and the base structure 1 (more specifically the power source 3 and the computing system 4), each of the plurality of legs 21 comprises a foot 211 and a top 212, which are positioned at opposite ends of said legs 21. The foot 211 itself comprises a connector 213, while the top 212 comprises a socket 214. This allows for communicable and electrical coupling between adjacent playing units 2 via the connector 213 and the socket 214. Restated, the connector 213 and the socket 214 allows for an arbitrary playing unit 25 to be both coupled with and attached atop a supporting playing unit 26. The coupling between playing units 2 is elaborated upon below.

Providing an arbitrary playing unit 25 and a supporting playing unit 26, the connector 213 of an arbitrary foot 215 (of the arbitrary playing unit 25) is coupled with the socket 214 of a supporting top 216 (from the supporting playing unit 26). Beyond providing electrical and communicable coupling between the power source 3, computing system 4, and virtual game piece generating unit 24, the connector 213 and the socket 214 serve to create a more secure coupling between corresponding legs 21 of adjacent playing units 2. The coupling is also non-permanent, allowing for playing units to be separated from each other. This allows users to adjust the number of playing units to a desired number, for example two playing units when first attempting multilevel chess. More playing units can be added as users become more experienced with multilevel chess. The ability to detach playing units from each other also makes it easier to store the present invention.

In different embodiments of the present invention, the virtual game piece generating unit 24 can take different forms. For example, in a holographic embodiment of the present invention the virtual game piece generating unit 24 is a holographic projector 241. The holographic projector 241 comprises a laser 242, which serves as a reconstruction beam as required for generating holographic images. In this embodiment, the game board 23 comprises a plurality of holographic film plates 231; a reconstruction beam generated by the laser 242 can display a holographic image which is imprinted on the holographic film plate. Thus, by shining the appropriate reconstruction beam at the appropriate holographic film plate, holographic chess pieces can be generated. The laser 242 itself is preferably mounted to one of the plurality of legs 21, providing said laser 242 with an unobstructed linear pathway to the plurality of holographic film plates 231. To provide the necessary energy for operation, the power source 3 is electrically connected to the laser 242.

In a video embodiment of the present invention, the virtual game piece generating unit 24 is a camera projection system 243. The camera projection system 243 comprises a video projector 244 which is oriented towards the game board 23 and which is capable of displaying a number of images, similar to how film projectors display images on movie screens. The video projector 244 is mounted into one of the plurality of legs 21 and oriented towards the game board 23, similar to the configuration of the laser 242 in the holographic embodiment. The video projector 244 creates a two dimensional image (compared to the three dimensional image of the holographic embodiment) on the game board 23. By means of the video projector 244, two dimensional projections of chess pieces can be superimposed onto the tiles of the game board 23. This allows for virtual game pieces to be generated in a manner similar to the holographic embodiment, with the primary difference being the either three-dimensional or two-dimensional nature of the chess pieces.

In an illuminated embodiment, the virtual game piece generating unit 24 is a plurality of illumination sources 245. A common example of such illumination sources 245 is light-emitting diodes (LED's). The plurality of illumination sources 245 is mounted onto the game board 23, with each of the plurality of illumination sources 245 corresponding to a specific area. For example, in the chess example each of the illumination sources 245 corresponds to a specific chess tile; thus there are a total of 64 illumination sources 245 for a chess game board 23. The illumination sources 245 are rendered operable by being electrically connected to the power source 3. Each illumination source can be engaged (i.e. switched on) in order to represent the current position of a given chess piece. Different chess pieces can be represented by different colors of light (e.g. blue light for pawns, green light for bishops, and so on). This illuminated embodiment serves as a simpler implementation, compared to the holographic embodiment and the video embodiment, helping to reduce costs and complexity associated with the present invention.

Further embodiments of the present invention are possible, with means other than a holograms, video projections, or LED's being utilized for the virtual game piece generating unit 24. Potentially, the virtual game piece generating unit 24 could even be omitted entirely; traditional physical game pieces would be used in combination with the multilevel gaming aspect of the present invention.

Facilitating the multilevel gaming aspect of the present invention is the slidable engagement between the game board 23 and the lateral bracket 22; by allowing the game board 23 to slide away from the lateral bracket 22, players are granted with improved access to the playing unit 2. Further describing this relation, the lateral bracket 22 comprises a first elongated member 221, a second elongated member 222, and at least one cross brace 223. The first elongated member 221 and the second elongated member 222 themselves each comprise a track 224. The at least one cross brace 223 is perpendicularly connected between the first elongated member 221 and the second elongate member. The track 224 serves to support the game board 23, which is slidably engaged along the track 224 of each elongated member. A game board 23 can thus be moved into or away from a corresponding lateral bracket 22.

For storage purposes, the present invention may comprises a storage compartment 11. The storage compartment 11 traverses through an opening into the base structure 1, allowing items (e.g. physical game pieces) to be stored within the base structure 1. Potentially, a drawer 12 can be provided for the storage compartment 11, with the drawer 12 being slidably engaged into the storage compartment 11. Alternatively, the storage compartment 11 could be closed off by a door or similar means.

The computing system 4 is provided to control operations of the virtual game piece generating unit 24. The computing system 4 comprises a processing module 41 and a communications module 42. The communications module 42 allows the computing system 4 to communicate with external devices (e.g. mobile phones, tablets, and other computer devices) while the processing module 41 is able to handle any received information and direct the corresponding instructions to the virtual game piece generating unit 24. The communications module 42 can potentially support wired connections, wireless connections, or both. To support wired connections, the communications module 42 can comprise an input port which traverses into the base structure 1. This allows for a direct connection to an external device to be established; a common means of doing so utilizes Universal Serial Bus (USB) technology, which is incorporated into a large number of electronics. Wireless technology can be enabled by transceivers or similar components that support various standards, such as Bluetooth or traditional wireless networks (branded together under Wi-Fi).

The communications module 42 supports linking with electronic devices, which can then provide updates to the present invention regarding positioning and movement of chess pieces. For example, a two persons could play a remote game of chess against each other by coupling their wireless-enabled smart phone to the present invention. Using a supporting software (often referred to as an “app”, short for “application”), players can input their moves, with the moves being transmitted to each coupled unit. The processing unit receives the moves through the communication module, and updates the virtual game piece generating unit 24 accordingly. The related process for this is described in more detail later.

A fixed game board 13 can potentially be directly connected atop the base structure 1, providing an additional playing surface. This could also be desirable for situations in which player want to play a game of chess on a single level, rather than attempting multilevel chess. The playing unit 2 could be removed and a standard game of chess could be played on the fixed game board 13 of the base structure 1.

The apparatus of the present invention, as describe dup to this point, supports a multilevel gaming unit which is compatible with electronic systems and related gaming software. This allows the apparatus of the present invention to serve as a physical representation of a multilevel chess game. As previously referenced, movement of game pieces made via a software can be transmitted to the apparatus of the present invention and physically represented. This facilitates matches against remote opponents in addition to providing a variety of design options for displaying virtual game pieces.

A method associated with the apparatus of the present invention involves receiving gameplay information from an electronic device, updating the virtual game piece generating unit 24 to reflect the received gameplay information, and confirming that the gameplay information has been received and acted upon.

The process beings by pairing with a personal electronic device (e.g. smart phone, tablet, computer, or such) with the present invention. This pairing is accomplished via the communications module 42; for wired pairing this is as simple as connecting one end of a cable to the communications module 42 and another to the personal electric device. For a wireless connection, this entails identifying each device (e.g. through menu showing wireless device) and subsequently bonding the communications module 42 with the personal electronic device.

Once pairing has been achieved, data can be transferred between the two devices. This allows for gameplay of the electronic device to be represented via the apparatus. The apparatus receives game piece display requests through the communications module 42; the game piece display requests could be, for example, requests to display pieces in a starting position (i.e. for a new game), moving an individual piece, and removing an individual piece (e.g. when a piece is captured).

Due to the complex nature of referencing a 3 dimensional position, the present invention parses each game piece display request into a current tile location and a desired tile location. The processing module 41 uses this parsed data to update the virtual game piece generating unit 24. More specifically, the virtual game piece generating is instructed to cease generating a representation of a game piece in the current tile location, and to begin generating a representation of the game piece in the desired tile location. Depending on the specific embodiment of the apparatus, such an action might entail refocusing a laser 242, updating a projected image, or turning off one LED and turning on another LED.

For games of chess, the present invention provides an updated chess notation system that not only identifies tile, but also identifies table. The table can be represented by an alphanumeric character which is inserted into the existing style of chess notation. For example, a2-2 could represent a pawn on tile a2 of the second playing unit. The addendum of a character representing can thus easily be used as part of existing chess nomenclature. As a further example, axb3-2 would represent the pawn on tile a2 of the second playing unit two moving to capture a piece on tile b3 of that same playing unit.

This notation allows moves to be clearly and concisely communicated, even in configurations with a large number (e.g. eight) of playing units. Movement of pieces can be displayed via a paired electronic device or transmitted directly between the processing units of gaming boards. The former may be desirable when players choose to use physical game pieces alongside or in place of virtual game piece representations.

The processing module 41 is able to communicate such movements (i.e. received from the paired electronic device) to the virtual game piece generating unit 24. The virtual game piece generating unit 24 can then update the displayed arrangement of pieces, such as displaying a pawn in a newly moved to square or ceasing to display a pawn after it has been captured by another piece. Preferably, the virtual game piece generating unit 24 is also capable of generating different types of game pieces. That is, in accordance with a games of chess, the virtual game piece generating unit 24 would generate virtual pawns, rooks, knights, bishops, kings, and queens. Alternatively, in accordance with a game of checkers, checker pieces can be displayed by the virtual game piece generating unit 24 (rather than chess pieces).

Potentially, in one embodiment, it could be desirable for a user interface to be integrated into the present invention, in place of requiring a separate personal electronic device such as a cell phone. For example, a display screen and input (e.g. touchpad or keyboard) could be installed into the base structure 1, allowing a user to select enter and verify their moves.

As another example, a display can be mounted to the frame of the present invention. In addition to serving as a user interface (which can further be enhanced by utilizing a touch capacitive display screen), such a display can also serve as a virtual game piece generating unit 24 and game board 23. Essentially, the display outputs a game board 23 along with game appropriate pieces (e.g. chess pieces or checkers pieces). In this manner, the display takes the functionality of the game board 23 and the virtual game piece generating unit 24 and combines them into a unified component.

Although the invention has been explained in relation to its preferred embodiment, it is to be understood that many other possible modifications and variations can be made without departing from the spirit and scope of the invention.

What is claimed is:

1. A modular holographic game assembly comprises:
a base structure;
an at least one playing unit;
a power source;
a computing system;
the at least one playing unit comprises a plurality of legs, a lateral bracket, a game board, and a virtual game piece generating unit;
the power source and the computing system being housed in the base structure;
the power source being electrically connected to the computing system and virtual game piece generating unit;
the plurality of legs being adjacently connected along the lateral bracket;
the plurality of legs being oriented normal to the game board;
the game board being slidably engaged into the lateral bracket; and
the at least one playing unit being positioned onto the base structure.

2. The modular holographic game assembly as claimed in claim 1 comprises:
the at least one playing unit comprises an arbitrary playing unit and a supporting playing unit;
each of the plurality of legs comprises a foot and a top;
the foot and the top being positioned opposite each other along each of the plurality of legs;
the arbitrary playing unit being coupled with the supporting playing unit; and
the arbitrary playing unit being attached atop the supporting playing unit.

3. The modular holographic game assembly as claimed in claim 2 comprises:
the foot comprises a connector;
the top comprises a socket; and
the connector of an arbitrary foot from the plurality of feet being coupled with the socket of a supporting top.

4. The modular holographic game assembly as claimed in claim 1 comprises:
the virtual game piece generating unit being a holographic projector;
the holographic projector comprises a laser, wherein a reconstruction beam is generated by the lasers;
the game board comprises a plurality of holographic film plates;
the laser being mounted into one of the plurality of legs;
the plurality of holographic film plates being patterned into a playing grid; and
the power source being electrically connected to the laser.

5. The modular holographic game assembly as claimed in claim 1 comprises:
the virtual game piece generating unit being a camera projection system;
the camera projection system comprises a video projector;
the video projector being mounted into one of the plurality of legs; and
the power source being electrically connected to the video projector.

6. The modular holographic game assembly as claimed in claim 1 comprises:
the virtual game piece generating unit being a plurality of illumination sources;
the plurality of illumination sources being mounted onto the game board;
the plurality of illumination sources being patterned into a playing grid; and
the power source being electrically connected to the plurality of illumination sources.

7. The modular holographic game assembly as claimed in claim 1 comprises:
the lateral bracket comprises a first elongated member, a second elongated member, and at least one cross-brace;
the first elongated member and the second elongated member each comprise a track;
the at least one cross brace being perpendicularly connected between the first elongated member and the second elongated member;
the first elongated member and the second elongated member being parallel with each other; and
the game board being slidably engaged along the track of the first elongated member and the track of the second elongated member.

8. The modular holographic game assembly as claimed in claim 1 comprises:
a fixed game board; and
the fixed game board being connected atop the base structure.

9. The modular holographic game assembly as claimed in claim 1 comprises:
a storage compartment; and
the storage compartment traversing through an opening into the base structure.

10. The modular holographic game assembly as claimed in claim 9 comprises:
a drawer; and
the drawer being slidably engaged into the storage compartment.

11. The modular holographic game assembly as claimed in claim 1 comprises:
the computing system comprises a processing module and a communications module;
the processing module being electronically connected to the virtual game piece generating unit and the communications module; and
the power source being electrically connected to the processing module and the communications module.
